(19) United States
(12) Patent Application Publication
(10) Pub. No.: US 2019/0062523 A1
(43) Pub. Date: Feb. 28, 2019

(54) CARBON / NANOTUBE GRAPHENE CONDUCTIVE ELASTOMERIC POLYMER COMPOUND

(71) Applicant: Intel Corporation, Santa Clara, CA (US)

(72) Inventors: Todd Harple, Hillsboro, OR (US); Francis Bitonti, Brooklyn, NY (US); Peter Wildfeuer, Brooklyn, NY (US)

(21) Appl. No.: 15/692,117

(22) Filed: Aug. 31, 2017

(51) Int. Cl. C08K 3/04; C08K 7/06; B29C 64/393; B29C 64/118; B33Y 50/02; B33Y 70/00; B33Y 30/00; B33Y 10/00

(52) U.S. Cl. CPC C08K 3/041; C08K 3/042; C08K 7/06; B29C 64/393; B29C 64/118; B29K 2105/162; B33Y 70/00; B33Y 30/00; B33Y 10/00; C08K 2201/001; B29K 2995/0005; B33Y 50/02

(57) ABSTRACT

Systems and methods for printed conductors include processes and compounds that include carbon nanotubes and graphene in elastomeric polymers to create and control resistivity and conductivity. In an embodiment, a compound may provide various processes and 3-D printing settings, such as a percentage of conductive material additive, a compounding process, a 3-D printing nozzle diameter, a 3-D printing layer height, a 3-D infill pattern, and other ingredients. The compound may provide a conductive device according to an input resistance profile. The conductive device may be further modified through tool pathing or printing geometries to produce various sensors, such as clothing sensors or padding sensors.

### TECHNICAL FIELD

Embodiments described herein generally relate to additive manufacturing.

### BACKGROUND

Increasingly, there is demand for sensors and circuitry to become flexible, stretchable, and water resistant. Presently, printing with silver inks and pastes and other metallic and alloy materials is common for printing onto fabrics, films, and flexible boards. Various metallic pastes, which work well on flexible PCBs have been tried.

### BRIEF DESCRIPTION OF THE DRAWINGS

FIGS. 1A-1B are perspective diagrams of a 3-D printer extruder, in accordance with at least one embodiment.

FIGS. 2A-2B are perspective diagrams of a 3-D printer nozzle diameters, in accordance with at least one embodiment.

FIGS. 3A-3C are perspective diagrams of a 3-D printer infill percentages, in accordance with at least one embodiment.

FIG. 4 is a perspective diagram of a 3-D printed object thickness, in accordance with at least one embodiment.

FIGS. 5A-5D are radar plots of 3-D printing parameters, in accordance with at least one embodiment.

FIG. 6 is a block diagram of a conductive elastomeric 3-D sensor printer method, in accordance with at least one embodiment.

FIG. 7 is a block diagram illustrating a 3-D printing system in the example form of an electronic device, according to an example embodiment.

### DESCRIPTION OF EMBODIMENTS

Metallic pastes that have been used for flexible PCBs are generally flexible during deposition, however, they are generally not flexible or water resistant after deposition. What is needed is an improved printed conductor. A solution to the technical problems facing printed conductors includes processes and compounds that include carbon nanotubes and graphene in elastomeric polymers to create and control resistivity and conductivity. In an embodiment, a compound (e.g., recipe) may provide various processes and 3-D printing settings, such as a percentage of conductive material additive, a compounding process, a 3-D printing nozzle diameter, a 3-D printing layer height, a 3-D infill pattern, and other ingredients. The compound may provide a conductive device (e.g., conductive sensor, conductive trace) according to an input resistance profile. The conductive device may be further modified through tool pathing or printing geometries to produce various sensors, such as clothing sensors or padding sensors.

In particular, these processes and compounds provide the ability to control and optimize 3-D printed thermoplastic elastomeric polymer such as Thermoplastic Polyurethane (TPU) with various printing additives, such as carbon nanotubes (CNT), graphene platelets, silver nanowires, or other additives. These processes and 3-D printing settings improve or maximize conductivity of the combined additive and thermoplastic elastomers. These recipes may be used to improve or optimize a variety of stretch, compression, and bend characteristics for 3-D printed circuits, sensors, and padding.

The solutions described herein allow users to adapt resistivity and conductivity or to enable resistance below 20 ohms per centimeter. In particular, the use of carbon nanotubes or graphene platelets provides the ability to select a custom resistivity down to 6 ohms per centimeter, enabling broader usage of conductive 3-D printing for customizable circuits, sensors, and traces. At the same time, the subject matter herein maintains conductivity with low levels of resistivity under elongation of over 250%.

The subject matter described herein provides a balance of carrier, conductive materials, and filament-based 3-D printing. This addresses three of the primary factors in 3-D printed sensors, including the flexibility of the final product, the conductivity of the final product, and the filament mechanical properties that enable the filament to pass through the 3-D printer. These solutions provide for a number of wearable conductive configurations based on 3-D printing of data acquisition circuits, sensors, or conductive traces. This subject matter also provides conductive materials for packaging, footwear, or garments, such as for suppliers of clothing and equipment for sports, fitness, fashion, electronics, and other industries.

The following description and the drawings illustrate example embodiments, though other embodiments may incorporate structural, logical, electrical, process, and other changes. Portions and features of various embodiments may be included in, or substituted for, those of other embodiments. Embodiments set forth in the claims encompass all available equivalents of those claims.

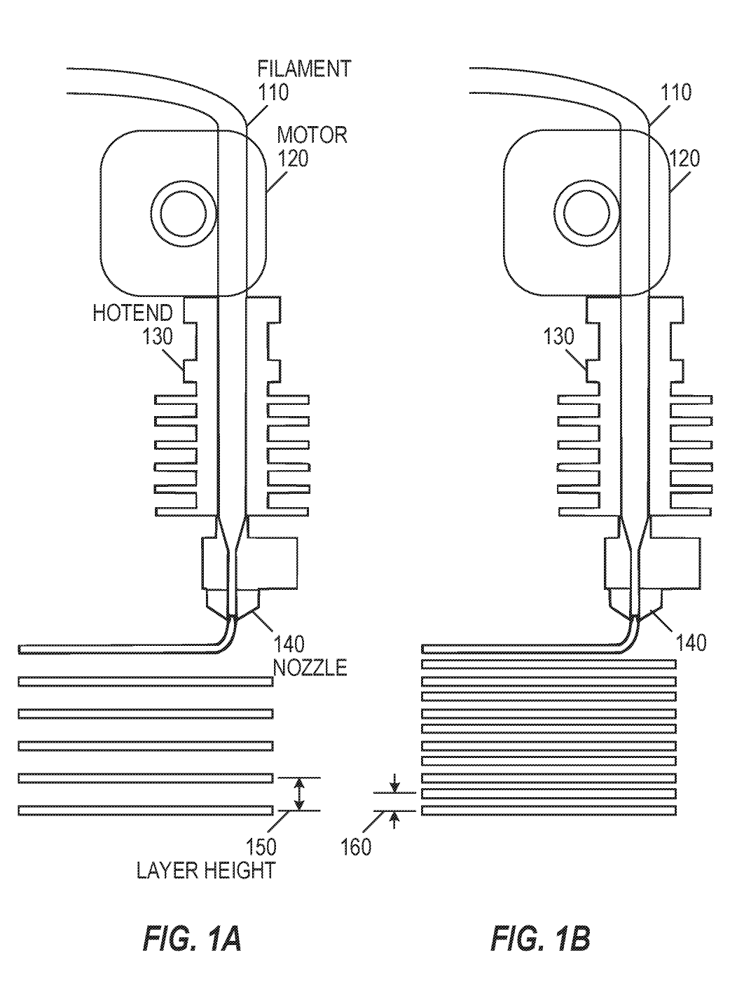

FIGS. 1A-1B are perspective diagrams of a 3-D printer extruder, in accordance with at least one embodiment. Extruder may include a motor 120 to feed a filament 120 through a hotend 130. The hotend 130 may include a thermal break, thermal sensor, a heater, and a heat sink. The hotend 130 is responsible for melting the filament 110 enough to flow through the nozzle 140.

Extruder may be controlled to provide a layer height, such as first selected layer height 150 or second selected layer height 160. The layer height defines the separation between printing layers in the z-axis (e.g. vertical axis). Higher layer heights result in less material overlap and therefore weaker geometry, but results in faster prints. For a stretch sensor, the layer height 150 was not found to have a significant effect on the stretch sensor performance. For a compression sensor, changes in layer height 150 had a significant effect on initial weight detection, but had limited other effects. In an example, the reduction of layer height 150 from 0.10 mm to 0.06 mm provides an approximately 30 g increase in sensitivity. For a bending sensor, changes in layer height 150 had a significant effect on initial weight detection, but had limited other effects.

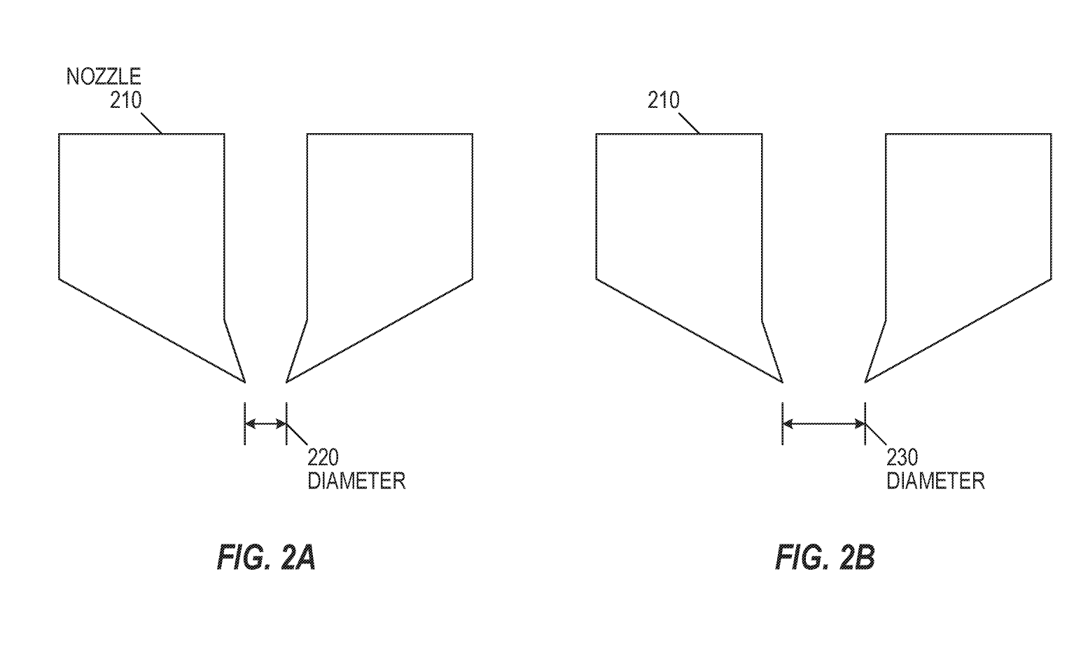

FIGS. 2A-2B are perspective diagrams of a 3-D printer nozzle diameters, in accordance with at least one embodiment. The nozzle 210 shown in FIGS. 2A-2B may correspond to the nozzle 140 shown in FIG. 1A. The nozzle 210 may have an associated first diameter 220 or an associated second diameter 220, where the second diameter 230 is greater than the first diameter 220. The nozzle diameter may be selected by adjusting a nozzle diameter or by replacing a nozzle.

The diameter of the nozzle relates to the thickness of a single line printed through the 3-D extruder. For a stretch sensor, nozzle diameter was not found to have a significant effect on the stretch sensor performance. For a compression sensor, while a 0.8 mm nozzle performs slightly better than a 1.2 mm nozzle, the 0.8 mm nozzle is not able to print thin geometries reliably at infill percentages below 20%. For a bending sensor, a 0.8 mm nozzle diameter provided superior results with respect to initial weight detection.

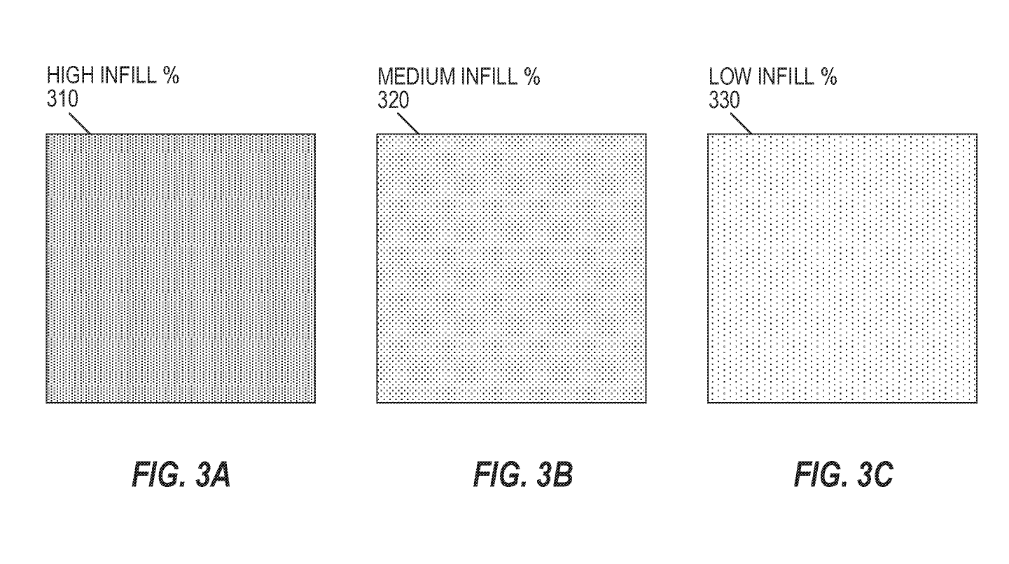

FIGS. 3A-3C are perspective diagrams of a 3-D printer infill percentages, in accordance with at least one embodiment. Infill percentage refer to the tool path that fills any solid printed geometry, where the filament printed per the infill percentage occupies the corresponding percentage of the interior of the printed object. FIG. 3A shows a high infill percentage 310, such as 100% infill. FIG. 3B shows a medium infill percentage 320, such as 50% infill. FIG. 3C shows a low infill percentage 330, such as 10% infill. For a stretch sensor, increasing infill percentage beyond 14% improves initial weight detection. For a compression sensor, increasing infill percentage significantly improves the sensing performance of the compression sensor. For a bending sensor, the performance of the sensor improves with increasing infill percentage, but does not increase significantly beyond 40% infill.

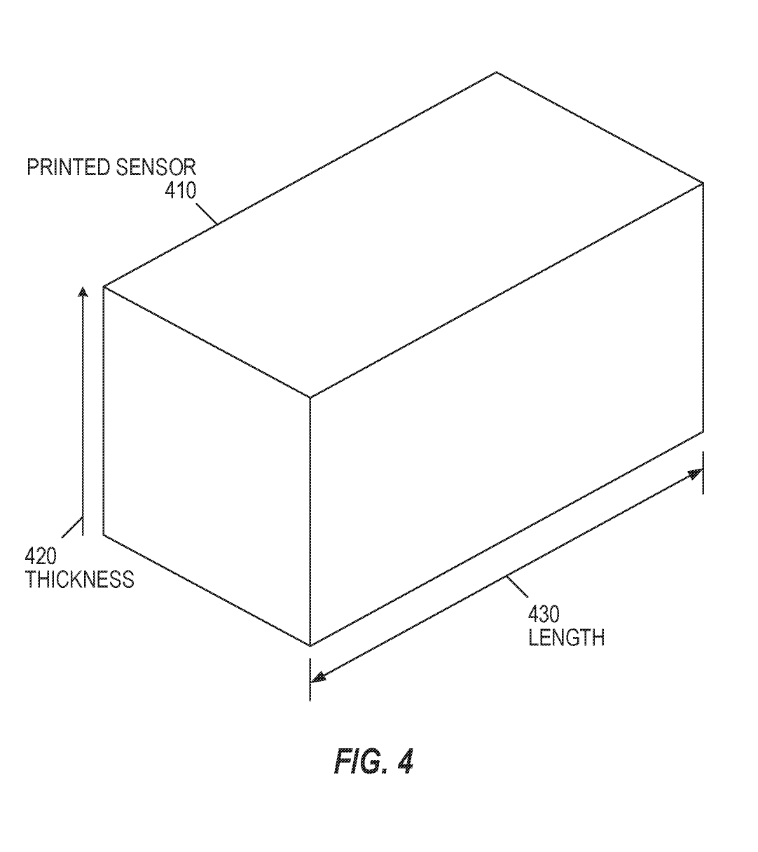

FIG. 4 is a perspective diagram of a 3-D printed object thickness, in accordance with at least one embodiment. The printed sensor 410 is shown as a block, though other structures may be used. Sensor 410 has an associated thickness 420 and length 430. For a 3-D printed sensor, the thickness 420 refers to the height of the sensor being 3-D printed. As the thickness 420 of a sensor 410 is increased, the sensor 410 becomes less flexible but more conductive. For a stretch sensor, a minimum of 0.8 mm was shown to provide reliable sensor performance. For a compression sensor, an increase in thickness (e.g., an increase in the sensor's conductive bands) generally results in a decrease in sensor performance. For a bending sensor, a decrease in thickness (e.g., a decrease in the sensor's conductive bands) generally results in a decrease in sensor performance.

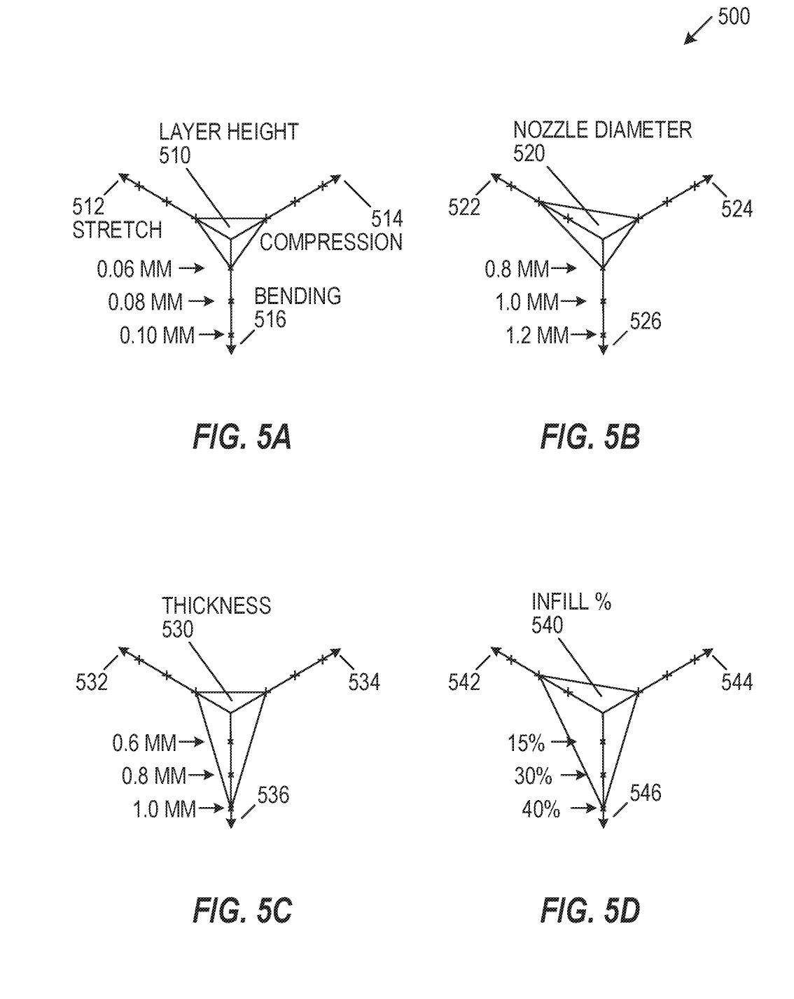

FIGS. 5A-5D are radar plots of 3-D printing parameters 500, in accordance with at least one embodiment. Parameters 500 may be selected in response to a selection of one or more sensor types. For example, the printed sensor may be selected provide only detection or sensor measurements of a bending of the sensor. In another example, the printed sensor may be selected to provide multiple sensing capabilities, such as detection of sensor measurements of stretching, compressing, and bending. Based on the selection of one or more sensor types, FIGS. 5A-5D show settings for layer height, nozzle diameter, thickness, and infill for printing this polymer to produce a variety of electromechanical sensors. The settings shown in FIGS. 5A-5D reduce or minimize the noise within the sensor signal-to-noise ratio. Parameters 500 correspond to settings for a combination of thermoplastic polyurethane (TPU) and carbon nanotube (CNT) 3-D printing additive, and may be adjusted for various combinations of TPU and various 3-D printing additives.

As shown in FIG. 5A, the layer height 510 may be selected to include a height 510 ranging from a minimum height through 0.06 mm for each of a stretch sensor 512, a compression sensor 514, or a bending sensor 516. As shown in FIG. 5B, the nozzle diameter 520 may be selected to include a nozzle diameter 520 ranging from a minimum diameter through 1.0 mm for a stretch sensor 522, ranging from a minimum height through 0.8 mm for a compression sensor 524, and ranging from a minimum height through 0.8 mm for a bending sensor 526. In the particular case of a selection of a stretch sensor 522, the nozzle diameter 520 may be selected to be ranging from 0.8 mm and 1.0 mm. As shown in FIG. 5C, the layer thickness 530 may be selected to include a thickness 530 ranging from a minimum height through 0.6 mm for a stretch sensor 532, ranging from a minimum height through 0.6 mm for a compression sensor 534, and ranging from a minimum height through 1.0 mm for a bending sensor 536. In the particular case of a selection of a bending sensor 536, the thickness 530 may be selected to be ranging from 0.8 mm and 1.0 mm. As shown in FIG. 5D, the infill percentage 540 may be selected to include an infill percentage 540 ranging from a minimum infill percentage and 30% for a stretch sensor 542, ranging from a minimum infill percentage and 15% for a compression sensor 544, and ranging from a minimum infill percentage and 40% for a bending sensor 536. In the particular case of a selection of a stretch sensor 542, the infill percentage 540 may be selected to range from 15% to 30%. In the particular case of a selection of a bending sensor 546, the infill percentage 540 may be selected to range from 30% to 40%.

Taken together, stretch sensor performance for heavy loading conditions may be improved or maximized by selecting a layer height 510 of approximately 0.06 mm, a nozzle diameter 520 of approximately 1.2 mm, a thickness 530 of approximately 1.0 mm, and an infill 540 of approximately 30%. Similarly, stretch sensor performance for lighter loading conditions may be improved or maximized by selecting a layer height 510 of approximately 0.06 mm, nozzle diameter 520 of approximately 0.8 mm, a thickness 530 of approximately 0.6 mm, and an infill 540 of approximately 40%. Compression sensor performance may be improved or maximized by selecting a layer height 510 of approximately 0.06 mm, a nozzle diameter 520 of approximately 0.8 mm, a thickness 530 of approximately 0.6 mm, and an infill 540 of approximately 40%. Bending sensor performance may be improved or maximized by selecting a layer height 510 of approximately 0.06 mm, a nozzle diameter 520 of approximately 0.8 mm, a thickness 530 of approximately 0.6 mm or 1.0 mm (based on flexibility requirements), and an infill 540 of approximately 40%.

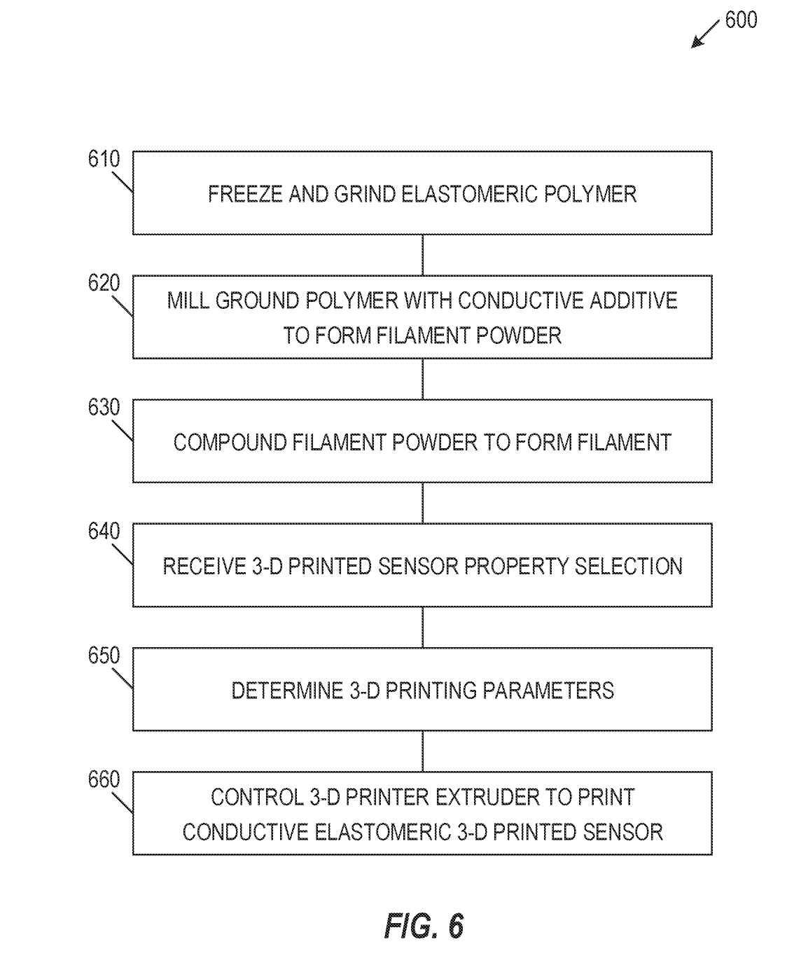

FIG. 6 is a block diagram of a conductive elastomeric 3-D sensor printer method 600, in accordance with at least one embodiment. Method 600 includes cryogenically freezing and grinding 610 an elastomeric polymer, such as TPU. Because elastomeric polymers are typically soft, cryogenically freezing 610 the elastomeric polymer enables it to be ground (e.g., crushed, milled).

Method 600 includes milling 620 a predetermined ratio of the ground elastomeric polymer with a conductive additive (e.g., CNT) to form a filament powder. In an embodiment, the conductive 3-D printing additive includes CNT and the predetermined ratio of the additive powder includes approximately 10% additive powder. Some existing conductive TPU solutions use carbon black as an additive at a 15% premix, however the resistivity of these solutions is limited to 1.0 ohm-meter. In contrast, application of method 600 using CNT at approximately 10% provides resistivity of 0.1 ohm-meters or less. The selection of ratio of the additive powder may be based on the desired resistivity.

The milling 620 may be performed using the same device and process as grinding 610 the elastomeric polymer, or may be performed using a different device or different process. The milling 620 enables the conductive additive to coat the elastomeric polymer, which pre-distribute the conductive additive particles before the resulting filament powder is provided to a screw compounder. The conductive additive may include CNT, graphene platelets, silver nanowires, or another conductive additive. In an embodiment, the selection of CNT as the conductive additive provides an improved dispersion relative to carbon black additive. In particular, carbon black particles are spherical, and provide a particular conductivity at a ratio of 15% carbon black additive. In contrast, CNT particles have a higher aspect ratio (e.g., particles whose height is substantially greater than the particle width). Even at a ratio of 10% additive, the CNT particles enable conductivity comparable to carbon black at a 15% additive ratio. However, the higher aspect ratio of CNT tends to cause clumping within screw compounders, which leads to uneven distribution of resistivity and other electrical characteristics. By freezing and grinding 610 the elastomeric polymer and milling 620 the elastomeric polymer with a conductive additive, the resulting filament powder improves or maximizes distribution (e.g., evenly distributed CNT in the polymer matrix) and dispersion (e.g., particles breaking apart to avoid clumping) for use in a conventional twin screw compounder.

Method 600 includes compounding 630 the filament powder within a screw compounder to form a 3-D printing filament. Some polymer compounders rely on screw compounding methodology that uses shear rate to achieve distribution of additive particles, however these compounders may not provide acceptable distribution of CNT with a TPU elastomer. The use of a co-rotating twin screw compounder, along with a predetermined ratio of the cryogenically frozen TPU with a CNT powder, improves or maximizes sensor performance. This enables the use of higher aspect ratio particles such as CNT to achieve an improved dispersed matrix and improved conductivity levels at lower additive concentrations.

Method 600 includes receiving 640 a 3-D printed sensor property selection, the sensor property selection including at least one of a stretch sensor, a compression sensor, and a bending sensor. Method 600 includes determining 650 a plurality of 3-D printing parameters based on the received sensor property selection. The selected plurality of 3-D printing parameters includes at least one of a layer height, a nozzle diameter, a layer thickness, and an infill percentage. Method 600 includes controlling 660 a 3-D printer extruder to print a conductive elastomeric 3-D printed sensor from the 3-D printing filament based on the determined plurality of 3-D printing parameters.

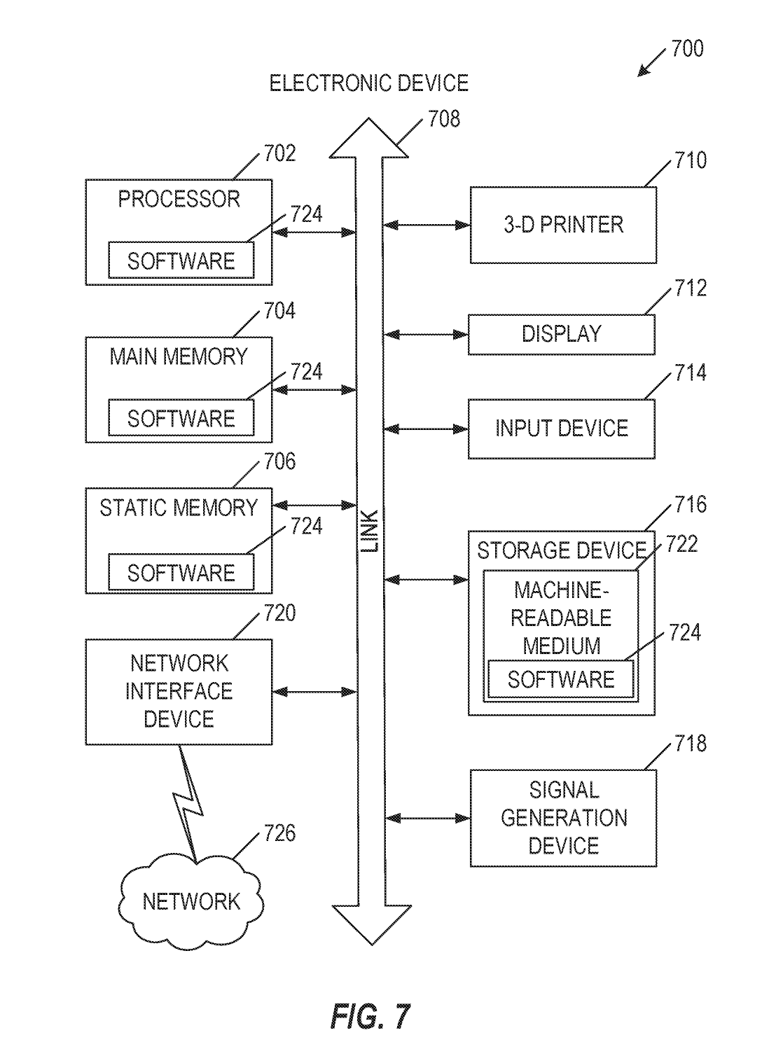

FIG. 7 is a block diagram illustrating a 3-D printing system in the example form of an electronic device 700, within which a set or sequence of instructions may be executed to cause the machine to perform any one of the methodologies discussed herein, according to an example embodiment. Electronic device 700 may also represent the devices shown in FIGS. 1-2. In alternative embodiments, the electronic device 700 operates as a standalone device or may be connected (e.g., networked) to other machines. In a networked deployment, the electronic device 700 may operate in the capacity of either a server or a client machine in server-client network environments, or it may act as a peer machine in peer-to-peer (or distributed) network environments. The electronic device 700 may be an integrated circuit (IC), a portable electronic device, a personal computer (PC), a tablet PC, a hybrid tablet, a personal digital assistant (PDA), a mobile telephone, or any electronic device 700 capable of executing instructions (sequential or otherwise) that specify actions to be taken by that machine to detect a user input. Further, while only a single electronic device 700 is illustrated, the terms “machine” or “electronic device” shall also be taken to include any collection of machines or devices that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to execute instructions, individually or jointly, to perform any one or more of the methodologies discussed herein.

Example electronic device 700 includes at least one processor 702 (e.g., a central processing unit (CPU), a graphics processing unit (GPU) or both, processor cores, compute nodes, etc.), a main memory 704 and a static memory 706, which communicate with each other via a link 708 (e.g., bus).

The electronic device 700 includes a 3-D printer 710, where the 3-D printer 710 may include an extruder as described above. The electronic device 700 may further include a display unit 712, where the display unit 712 may include a single component that provides a user-readable display and a protective layer, or another display type. The electronic device 700 may further include an input device 714, such as a pushbutton, a keyboard, an NFC card reader, or a user interface (UI) navigation device (e.g., a touch-sensitive input). The electronic device 700 may additionally include a storage device 716, such as a solid-state drive (SSD) unit. The electronic device 700 may additionally include a signal generation device 718 to provide audible or visual feedback, such as a speaker to provide an audible feedback or one or more LEDs to provide a visual feedback. The electronic device 700 may additionally include a network interface device 720, and one or more additional sensors (not shown), such as a global positioning system (GPS) sensor, compass, accelerometer, or other sensor.

The storage device 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704, static memory 706, and/or within the processor 702 during execution thereof by the electronic device 700. The main memory 704, static memory 706, and the processor 702 may also constitute machine-readable media.

While the machine-readable medium 722 is illustrated in an example embodiment to be a single medium, the term “machine-readable medium” may include a single medium or multiple media (e.g., a centralized or distributed database, and/or associated caches and servers) that store the one or more instructions 724. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of well-known transfer protocols (e.g., HTTP). Examples of communication networks include a local area network (LAN), a wide area network (WAN), the Internet, mobile telephone networks, and wireless data networks (e.g., Wi-Fi, NFC, Bluetooth, Bluetooth LE, 3G, 5G LTE/LTE-A, WiMAX networks, etc.). The term “transmission medium” shall be taken to include any intangible medium that is capable of storing, encoding, or carrying instructions for execution by the machine, and includes digital or analog communications signals or other intangible medium to facilitate communication of such software.

To better illustrate the method and apparatuses disclosed herein, a non-limiting list of embodiments is provided here.

Example 1 is a conductive elastomeric 3-D printer comprising: an extruder to receive a 3-D printing filament, the 3-D printing filament including a predetermined ratio of a conductive 3-D printing additive and cryogenically frozen and ground thermoplastic polyurethane (TPU); and a processing circuitry to determine a plurality of 3-D printing parameters based on a received 3-D printed sensor property selection and cause the extruder to print a conductive elastomeric 3-D printed device from the 3-D printing filament based on the determined plurality of 3-D printing parameters.

In Example 2, the subject matter of Example 1 optionally includes wherein: the 3-D printed device includes a 3-D printed sensor; and the sensor property selection includes at least one of a stretch sensor, a compression sensor, and a bending sensor.

In Example 3, the subject matter of Example 2 optionally includes wherein the predetermined ratio of the conductive 3-D printing additive is milled with the cryogenically frozen and ground TPU to form a conductive filament powder.

In Example 4, the subject matter of Example 3 optionally includes wherein the 3-D printing filament is formed by compounding the conductive filament powder within a co-rotating twin screw compounder.

In Example 5, the subject matter of any one or more of Examples 2-4 optionally include wherein the conductive 3-D printing additive includes at least one of carbon nanotubes (CNT), graphene platelets, and silver nanowires.

In Example 6, the subject matter of Example 5 optionally includes 10% conductive 3-D printing additive.

In Example 7, the subject matter of any one or more of Examples 2-6 optionally include wherein the selected plurality of 3-D printing parameters includes at least one of a layer height, a nozzle diameter, a layer thickness, and an infill percentage.

In Example 8, the subject matter of Example 7 optionally includes wherein: the sensor property selection includes the stretch sensor; and the selected plurality of 3-D printing parameters includes the layer height of less than or equal to 0.06 mm, the nozzle diameter ranging from 0.8 mm to 1.2 mm, the thickness of less than or equal to 1.0 mm, and the infill percentage ranging from 15% to 30%.

In Example 9, the subject matter of any one or more of Examples 7-8 optionally include wherein: the sensor property selection includes the compression sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 10, the subject matter of any one or more of Examples 7-9 optionally include wherein: the sensor property selection includes the bending sensor; and the selected plurality of 3-D printing parameters includes the layer height of less than or equal to 0.06 mm, the nozzle diameter of less than or equal to 0.8 mm, the thickness ranging from 0.8 mm to 1.0 mm, and the infill percentage ranging from 30% to 40%.

In Example 11, the subject matter of any one or more of Examples 7-10 optionally include wherein: the sensor property selection includes the stretch sensor and the compression sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 12, the subject matter of any one or more of Examples 7-11 optionally include wherein: the sensor property selection includes the compression sensor and the bending sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 13, the subject matter of any one or more of Examples 7-12 optionally include wherein: the sensor property selection includes the bending sensor and the stretch sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage ranging from 15% to 30%.

In Example 14, the subject matter of any one or more of Examples 7-13 optionally include wherein: the sensor property selection includes the stretch sensor, the compression sensor, and the bending sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

Example 15 is a conductive elastomeric 3-D printed device method comprising: receiving a 3-D printed device property selection; determining a plurality of 3-D printing parameters based on the received sensor property selection; receiving a 3-D printing filament at an extruder, the 3-D printing filament including a predetermined ratio of a conductive 3-D printing additive and cryogenically frozen and ground thermoplastic polyurethane (TPU); and controlling the extruder to print a conductive elastomeric 3-D printed device from the 3-D printing filament based on the determined plurality of 3-D printing parameters.

In Example 16, the subject matter of Example 15 optionally includes wherein: the 3-D printed device includes a 3-D printed sensor; and the printed device property selection includes at least one of a stretch sensor, a compression sensor, and a bending sensor.

In Example 17, the subject matter of Example 16 optionally includes milling the predetermined ratio of the conductive 3-D printing additive with the cryogenically frozen and ground TPU to form a conductive filament powder.

In Example 18, the subject matter of Example 17 optionally includes compounding the conductive filament powder within a co-rotating twin screw compounder to form the 3-D printing filament.

In Example 19, the subject matter of any one or more of Examples 16-18 optionally include wherein the conductive 3-D printing additive includes at least one of carbon nanotubes (CNT), graphene platelets, and silver nanowires.

In Example 20, the subject matter of Example 19 optionally includes 10% conductive 3-D printing additive.

In Example 21, the subject matter of any one or more of Examples 16-20 optionally include wherein the selected plurality of 3-D printing parameters includes at least one of a layer height, a nozzle diameter, a layer thickness, and an infill percentage.

In Example 22, the subject matter of Example 21 optionally includes wherein: the sensor property selection includes the stretch sensor; and the selected plurality of 3-D printing parameters includes the layer height of less than or equal to 0.06 mm, the nozzle diameter ranging from 0.8 mm to 1.2 mm, the thickness of less than or equal to 1.0 mm, and the infill percentage ranging from 15% to 30%.

In Example 23, the subject matter of any one or more of Examples 21-22 optionally include wherein: the sensor property selection includes the compression sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 24, the subject matter of any one or more of Examples 21-23 optionally include wherein: the sensor property selection includes the bending sensor; and the selected plurality of 3-D printing parameters includes the layer height of less than or equal to 0.06 mm, the nozzle diameter of less than or equal to 0.8 mm, the thickness ranging from 0.8 mm to 1.0 mm, and the infill percentage ranging from 30% to 40%.

In Example 25, the subject matter of any one or more of Examples 21-24 optionally include wherein: the sensor property selection includes the stretch sensor and the compression sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 26, the subject matter of any one or more of Examples 21-25 optionally include wherein: the sensor property selection includes the compression sensor and the bending sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 27, the subject matter of any one or more of Examples 21-26 optionally include wherein: the sensor property selection includes the bending sensor and the stretch sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage ranging from 15% to 30%.

In Example 28, the subject matter of any one or more of Examples 21-27 optionally include wherein: the sensor property selection includes the stretch sensor, the compression sensor, and the bending sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

Example 29 is at least one machine-readable medium including instructions, which when executed by a computing system, cause the computing system to perform any of the methods of Examples 15-28.

Example 30 is an apparatus comprising means for performing any of the methods of Examples 15-28.

Example 31 is at least one machine-readable storage medium, comprising a plurality of instructions that, responsive to being executed with processor circuitry of a computer-controlled device, cause the computer-controlled device to: receive a 3-D printed device property selection; determine a plurality of 3-D printing parameters based on the received sensor property selection; receive a 3-D printing filament at an extruder, the 3-D printing filament including a predetermined ratio of a conductive 3-D printing additive and cryogenically frozen and ground thermoplastic polyurethane (TPU); and control the extruder to print a conductive elastomeric 3-D printed device from the 3-D printing filament based on the determined plurality of 3-D printing parameters.

In Example 32, the subject matter of Example 31 optionally includes wherein the 3-D printed device includes a 3-D printed sensor; and the printed device property selection includes at least one of a stretch sensor, a compression sensor, and a bending sensor.

In Example 33, the subject matter of Example 32 optionally includes the instructions further causing the computer-controlled device to: mill the predetermined ratio of the conductive 3-D printing additive with the cryogenically frozen and ground TPU to form a conductive filament powder.

In Example 34, the subject matter of Example 33 optionally includes the instructions further causing the computer-controlled device to compound the conductive filament powder within a co-rotating twin screw compounder to form the 3-D printing filament.

In Example 35, the subject matter of any one or more of Examples 32-34 optionally include wherein the conductive 3-D printing additive includes at least one of carbon nanotubes (CNT), graphene platelets, and silver nanowires.

In Example 36, the subject matter of Example 35 optionally includes 10% conductive 3-D printing additive.

In Example 37, the subject matter of any one or more of Examples 32-36 optionally include wherein the selected plurality of 3-D printing parameters includes at least one of a layer height, a nozzle diameter, a layer thickness, and an infill percentage.

In Example 38, the subject matter of Example 37 optionally includes wherein: the sensor property selection includes the stretch sensor; and the selected plurality of 3-D printing parameters includes the layer height of less than or equal to 0.06 mm, the nozzle diameter ranging from 0.8 mm to 1.2 mm, the thickness of less than or equal to 1.0 mm, and the infill percentage ranging from 15% to 30%.

In Example 39, the subject matter of any one or more of Examples 37-38 optionally include wherein: the sensor property selection includes the compression sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 40, the subject matter of any one or more of Examples 37-39 optionally include wherein: the sensor property selection includes the bending sensor; and the selected plurality of 3-D printing parameters includes the layer height of less than or equal to 0.06 mm, the nozzle diameter of less than or equal to 0.8 mm, the thickness ranging from 0.8 mm to 1.0 mm, and the infill percentage ranging from 30% to 40%.

In Example 41, the subject matter of any one or more of Examples 37-40 optionally include wherein: the sensor property selection includes the stretch sensor and the compression sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 42, the subject matter of any one or more of Examples 37-41 optionally include wherein: the sensor property selection includes the compression sensor and the bending sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 43, the subject matter of any one or more of Examples 37-42 optionally include wherein: the sensor property selection includes the bending sensor and the stretch sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage ranging from 15% to 30%.

In Example 44, the subject matter of any one or more of Examples 37-43 optionally include wherein: the sensor property selection includes the stretch sensor, the compression sensor, and the bending sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

Example 45 is a conductive elastomeric 3-D printed device apparatus comprising: means for receiving a 3-D printed device property selection; means for determining a plurality of 3-D printing parameters based on the received sensor property selection; means for receiving a 3-D printing filament at an extruder, the 3-D printing filament including a predetermined ratio of a conductive 3-D printing additive and cryogenically frozen and ground thermoplastic polyurethane (TPU); and means for controlling the extruder to print a conductive elastomeric 3-D printed device from the 3-D printing filament based on the determined plurality of 3-D printing parameters.

In Example 46, the subject matter of Example 45 optionally includes wherein: the 3-D printed device includes a 3-D printed sensor; and the printed device property selection includes at least one of a stretch sensor, a compression sensor, and a bending sensor.

In Example 47, the subject matter of Example 46 optionally includes means for milling the predetermined ratio of the conductive 3-D printing additive with the cryogenically frozen and ground TPU to form a conductive filament powder.

In Example 48, the subject matter of Example 47 optionally includes means for compounding the conductive filament powder within a co-rotating twin screw compounder to form the 3-D printing filament.

In Example 49, the subject matter of any one or more of Examples 46-48 optionally include wherein the conductive 3-D printing additive includes at least one of carbon nanotubes (CNT), graphene platelets, and silver nanowires.

In Example 50, the subject matter of Example 49 optionally includes 10% conductive 3-D printing additive.

In Example 51, the subject matter of any one or more of Examples 46-50 optionally include wherein the selected plurality of 3-D printing parameters includes at least one of a layer height, a nozzle diameter, a layer thickness, and an infill percentage.

In Example 52, the subject matter of Example 51 optionally includes wherein: the sensor property selection includes the stretch sensor; and the selected plurality of 3-D printing parameters includes the layer height of less than or equal to 0.06 mm, the nozzle diameter ranging from 0.8 mm to 1.2 mm, the thickness of less than or equal to 1.0 mm, and the infill percentage ranging from 15% to 30%.

In Example 53, the subject matter of any one or more of Examples 51-52 optionally include wherein: the sensor property selection includes the compression sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 54, the subject matter of any one or more of Examples 51-53 optionally include wherein: the sensor property selection includes the bending sensor; and the selected plurality of 3-D printing parameters includes the layer height of less than or equal to 0.06 mm, the nozzle diameter of less than or equal to 0.8 mm, the thickness ranging from 0.8 mm to 1.0 mm, and the infill percentage ranging from 30% to 40%.

In Example 55, the subject matter of any one or more of Examples 51-54 optionally include wherein: the sensor property selection includes the stretch sensor and the compression sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 56, the subject matter of any one or more of Examples 51-55 optionally include wherein: the sensor property selection includes the compression sensor and the bending sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

In Example 57, the subject matter of any one or more of Examples 51-56 optionally include wherein: the sensor property selection includes the bending sensor and the stretch sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage ranging from 15% to 30%.

In Example 58, the subject matter of any one or more of Examples 51-57 optionally include wherein: the sensor property selection includes the stretch sensor, the compression sensor, and the bending sensor; and the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

Example 59 is at least one machine-readable medium including instructions, which when executed by a machine, cause the machine to perform operations of any of the operations of Examples 1-58.

Example 60 is an apparatus comprising means for performing any of the operations of Examples 1-58.

Example 61 is a system to perform the operations of any of the Examples 1-58.

Example 62 is a method to perform the operations of any of the Examples 1-58.

The above detailed description includes references to the accompanying drawings, which form a part of the detailed description. The drawings show, by way of illustration, specific embodiments in which the subject matter can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. In the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope should be determined with reference to the appended claims, along with the full scope of equivalents to which such claims are entitled.

1. A conductive elastomeric 3-D printer comprising:
an extruder to receive a 3-D printing filament, the 3-D printing filament including a predetermined ratio of a conductive 3-D printing additive and cryogenically frozen and ground thermoplastic polyurethane (TPU); and
a processing circuitry to determine a plurality of 3-D printing parameters based on a received 3-D printed sensor property selection and cause the extruder to print a conductive elastomeric 3-D printed device from the 3-D printing filament based on the determined plurality of 3-D printing parameters.

2. The 3-D printer of claim 1, wherein:
the 3-D printed device includes a 3-D printed sensor; and
the sensor property selection includes at least one of a stretch sensor, a compression sensor, and a bending sensor.

3. The 3-D printer of claim 2, wherein the predetermined ratio of the conductive 3-D printing additive is milled with the cryogenically frozen and ground TPU to form a conductive filament powder.

4. The 3-D printer of claim 3, wherein the 3-D printing filament is formed by compounding the conductive filament powder within a co-rotating twin screw compounder.

5. The 3-D printer of claim 2, wherein the conductive 3-D printing additive includes at least one of carbon nanotubes (CNT), graphene platelets, and silver nanowires.

6. The 3-D printer of claim 5, wherein the predetermined ratio includes approximately 10% conductive 3-D printing additive.

7. The 3-D printer of claim 2, wherein the selected plurality of 3-D printing parameters includes at least one of a layer height, a nozzle diameter, a layer thickness, and an infill percentage.

8. The 3-D printer of claim 7, wherein:
the sensor property selection includes the stretch sensor; and
the selected plurality of 3-D printing parameters includes the layer height of less than or equal to 0.06 mm, the nozzle diameter ranging from 0.8 mm to 1.2 mm, the thickness of less than or equal to 1.0 mm, and the infill percentage ranging from 15% to 30%.

9. The 3-D printer of claim 7, wherein:
the sensor property selection includes the compression sensor; and
the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

10. The 3-D printer of claim 7, wherein:
the sensor property selection includes the bending sensor; and
the selected plurality of 3-D printing parameters includes the layer height of less than or equal to 0.06 mm, the nozzle diameter of less than or equal to 0.8 mm, the thickness ranging from 0.8 mm to 1.0 mm, and the infill percentage ranging from 30% to 40%.

11. The 3-D printer of claim 7, wherein:
the sensor property selection includes the stretch sensor and the compression sensor; and
the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

12. The 3-D printer of claim 7, wherein:
the sensor property selection includes the compression sensor and the bending sensor; and
the selected plurality of 3-D printing parameters includes the layer height of less than or equal to 0.06 mm, the nozzle diameter of less than or equal to 0.8 mm, the thickness of less than or equal to 0.6 mm, and the infill percentage of less than or equal to 15%.

13. The 3-D printer of claim 7, wherein:
the sensor property selection includes the bending sensor and the stretch sensor; and
the selected plurality of 3-D printing parameters includes the layer height of less than or equal to 0.06 mm, the nozzle diameter of less than or equal to 0.8 mm, the thickness of less than or equal to 0.6 mm, and the infill percentage ranging from 15% to 30%.

14. A conductive elastomeric 3-D printed device method comprising:
receiving a 3-D printed device property selection;
determining a plurality of 3-D printing parameters based on the received sensor property selection;
receiving a 3-D printing filament at an extruder, the 3-D printing filament including a predetermined ratio of a conductive 3-D printing additive and cryogenically frozen and ground thermoplastic polyurethane (TPU); and
controlling the extruder to print a conductive elastomeric 3-D printed device from the 3-D printing filament based on the determined plurality of 3-D printing parameters.

15. The method of claim 14, wherein:
the 3-D printed device includes a 3-D printed sensor; and
the printed device property selection includes at least one of a stretch sensor, a compression sensor, and a bending sensor.

16. The method of claim 15, further including milling the predetermined ratio of the conductive 3-D printing additive with the cryogenically frozen and ground TPU to form a conductive filament powder.

17. The method of claim 16, further including compounding the conductive filament powder within a co-rotating twin screw compounder to form the 3-D printing filament.

18. The method of claim 15, wherein the conductive 3-D printing additive includes at least one of carbon nanotubes (CNT), graphene platelets, and silver nanowires.

19. At least one machine-readable storage medium, comprising a plurality of instructions that, responsive to being executed with processor circuitry of a computer-controlled device, cause the computer-controlled device to:
receive a 3-D printed device property selection;
determine a plurality of 3-D printing parameters based on the received sensor property selection;
receive a 3-D printing filament at an extruder, the 3-D printing filament including a predetermined ratio of a conductive 3-D printing additive and cryogenically frozen and ground thermoplastic polyurethane (TPU); and
control the extruder to print a conductive elastomeric 3-D printed device from the 3-D printing filament based on the determined plurality of 3-D printing parameters.

20. The machine-readable storage medium of claim 19, wherein
the 3-D printed device includes a 3-D printed sensor; and
the printed device property selection includes at least one of a stretch sensor, a compression sensor, and a bending sensor.

21. The machine-readable storage medium of claim 20, the instructions further causing the computer-controlled device to:
mill the predetermined ratio of the conductive 3-D printing additive with the cryogenically frozen and ground TPU to form a conductive filament powder.

22. The machine-readable storage medium of claim 21, the instructions further causing the computer-controlled device to compound the conductive filament powder within a co-rotating twin screw compounder to form the 3-D printing filament.

23. The machine-readable storage medium of claim 20, wherein the conductive 3-D printing additive includes at least one of carbon nanotubes (CNT), graphene platelets, and silver nanowires.

24. The machine-readable storage medium of claim 23, wherein the predetermined ratio of the conductive 3-D printing additive includes approximately 10% conductive 3-D printing additive.

25. The machine-readable storage medium of claim 20, wherein the selected plurality of 3-D printing parameters includes at least one of a layer height, a nozzle diameter, a layer thickness, and an infill percentage.
